(19) United States
(12) Patent Application Publication
(10) Pub. No.: US 2008/0307045 A1
(43) Pub. Date: Dec. 11, 2008

(54) METHOD, SYSTEM AND APPARATUS FOR MANAGING DIRECTORY INFORMATION

(75) Inventor: Tomoyuki TERADA, Toyonaka-shi (JP)

Correspondence Address: SIDLEY AUSTIN LLP, 717 NORTH HARWOOD, SUITE 3400, DALLAS, TX, 75201, US

(73) Assignee: Konica Minolta Holdings, Inc., Tokyo (JP)

(21) Appl. No.: 12/131,428

(22) Filed: Jun. 2, 2008

(30) Foreign Application Priority Data
Jun. 5, 2007 (JP) 2007-149071

(51) Int. Cl. G06F 15/16

(52) U.S. Cl. 709/203

(57) ABSTRACT

In file management using directory information in a network system, a method of managing the directory information, a management system and a management apparatus are provided, in which other more important processes such as file transfer are not disturbed due to increase in traffic when making inquiries to other nodes about the directory information. Upon receiving inquiries about the directory information, each node receiving the inquiry transmits data while adjusting the communication traffic of each node not to exceed a prescribed value, and this suppresses the communication load on the network not to be excessive.

This application is based on Japanese Patent Application No. 2007-149071 filed on Jun. 5, 2007, in Japanese Patent Office, the entire content of which is hereby incorporated by reference.

### TECHNICAL FIELD

The present invention relates to a method, system and apparatus for managing directory information in a network in which files are distributed and shared between a plurality of nodes.

### BACKGROUND

In recent years, networks having communication forms in which transmission and reception of data are executed between any nodes constituting the network have become frequently used.

Conventionally, centralized processing type networks were the most common. In this system, a server playing the role of a host is located at the center, a plurality of terminals functioning as clients access the host server, and if an exchange is necessary between the terminals, the exchange is carried out via the host server.

In contrast to this, so-called distributed processing type networks are gradually emerging. In the distributed processing type network, the functions of distributing information to save and of distributing the processing of that information are realized.

Systems have been developed and utilized which systems use efficiently the network form of such distributed processing, distribute and share data files between any nodes, and use the files mutually by carrying out data transmission and reception.

By employing these systems, the degree of freedom as the usage form of network systems has been increased, and the users have obtained larger convenience. On the other hand, the communication traffic between nodes has been increased, and it is likely to occur that an excessive load is imposed on the network.

For example, if data is shared and stored, although the users can share a larger quantity of data as the size of the network becomes larger, it is impossible to obtain that data only by accessing a certain server in the conventional manner. To begin with, it is necessary to search which node in the wide network is storing the necessary data file. Next, it is necessary to access the found node to obtain the required file.

As a technology for searching the node having the required file, so far a method has been used in which the nodes in the network are accessed and inquired whether they have the required file whenever a file is required.

However, although the degree of freedom is high in this method, a large load is imposed every time a file is accessed since exhaustive inquiry to many nodes has to be made. The load on the network associated with the processing is high, and consequently, a long time may be required to access the file, or other important processes may not be executed due to that large load.

In contrast to this, a management method has been proposed (see Unexamined Japanese Patent Application Publication No. H11-312114 and Unexamined Japanese Patent Application Publication No. 2002-244906), in which directory information (information giving the correspondence relationship between files and the nodes having those files) is stored in each node or in some of the nodes, thereby making it possible to refer to the node having each of the files distributed and shared.

In Unexamined Japanese Patent Application Publication No. H11-312114 has proposed a technology in which a centralized data management system has a centralized file management table and centrally manages a plurality of files in a data processing system. Further, in Unexamined Japanese Patent Application Publication No. 2002-244906 has proposed a technology in which shared file reference information which includes the information of where the shared file is stored is exchanged between the computers.

In such a technology, a node requiring to access a file first accesses and refers to the directory information indicating which node has the target file thereby finding out the node having the target file, and thereafter accesses that node and obtains the target file.

Of course, it is necessary that the directory information is reflecting the latest file possession status, generally in such a technology, whenever a new file is added or a file is deleted in each node, by posting that information to the node having the directory information, the directory information is speedily updated.

However, in file management method using the directory information as described above, it is necessary to make inquiries to other nodes in order to maintain the latest directory information. This is because, for example, when the network becomes disconnected temporarily, or when a node is shut down temporarily, the information of the file that was added or deleted during that period is not reflected in the directory information.

In such a situation, it is necessary for the node retaining the directory information to make an operation of inquiring other nodes for the file list indicating which node has which file.

Such inquiry operations have to be exhaustively made to a number of widespread nodes having files at the same time, and have to receive transmitted data, whereby a large load can be caused on the network.

In other words, depending on the size of the network, specifically, depending on the number of nodes and number of files, there will be too much work of updating the directory information, and the other necessary operations such as file transfer may get delayed.

### SUMMARY

A purpose of the present invention is to solve the above-mentioned problems and to provide, in a file management method using directory information in a network system, a method of managing directory information, a network system, and an information processing apparatus in which, even when making inquiries related to the directory information to other nodes, important processes such as file transfer are not delayed due to increase in traffic.

In view of forgoing, one embodiment according to one aspect of the present invention is a method of managing directory information in a network system in which files are distributed and shared between a plurality of nodes, the method comprising the steps of:

issuing a request for a list of files stored in the second node from a first node to a second node, the first node storing directory information indicating which node holds a file;

transmitting the list from the second node, which has received the request, to the first node while adjusting time average traffic not to excess a predetermined value; and

updating the directory information stored in the first node based on the list received from the second node.

According to another aspect of the present invention, another embodiment is a network system in which files are distributed and shared between a plurality of nodes, the network system comprising:

a first node which is adapted to store directory information indicating which node stores a shared file;

a second node which is able to communicate with the first node,

wherein the first node includes:
a first storage section for storing the directory information;
a request section which is adapted to request from the second node a list of files stored in the second node; and
an updating section which is adapted to update the directory information based on the list received from the second node,

and, the second node includes:
a second storage section for storing the files;
a list generation section which is adapted to generate the list of the files stored in the second storage section; and
a transmission section which is adapted to transmit, when the list of the files is requested from the second node, the list generated by the list generation section while adjusting time average traffic not to excess a predetermined value.

According to another aspect of the present invention, another embodiment is an information processing apparatus in a network system in which files are distributed and shared between a plurality of information processing apparatuses, the information processing apparatus comprising:

a file storage section for storing files shared with other information processing apparatuses;

a directory storage section which is adapted to store directory information indicating which information processing apparatus stores which of the files shared in the network system;

a request section which is adapted to request from a first another information processing apparatus a list of files stored in the another information processing apparatus;

an updating section which is adapted to update the directory information stored in the directory storage section based on the list received from the first another information processing section;

a list generation section which is adapted to generate a list of the files stored in the file storage section; and

a transmission section which is adapted to transmit, when the list of the files is requested by a second another information processing apparatus, the list generated by the list generation section to the second another information processing apparatus while adjusting time average traffic not to excess a predetermined value.

### BRIEF DESCRIPTION OF THE DRAWINGS

FIG. 1 is a diagram showing an example of the overall configuration of a network 1;

FIG. 2 is diagram showing schematically the structure of an overlay network (duality of physical and logical connections);

FIG. 3 is a diagram showing an example of the hardware configuration of nodes (terminal devices) 2 that constitute a network 1;

FIG. 4 is a diagram showing an example of the connection form of each of the nodes 2 constituting the network 1, that is, the logical topology of nodes;

FIG. 5 is a diagram showing an example of the connection table TL of the nodes 2 which are associated as shown in FIG. 4;

FIG. 6a is a block diagram showing an example of the functional configuration of the nodes 2 (terminal devices);

FIG. 6b is a diagram showing the internal configuration of the functions of the control section 101;

FIG. 7 is a flow chart showing the flow of a process for activating the processes necessary for file management using directory information and management of the directory information;

FIG. 8 is a flow chart showing the flow of a process example of a directory information requesting process;

FIG. 9 is a flow chart showing the flow of process example of a directory information transmitting process;

FIG. 10 is a flow chart showing the flow of process example of a directory information updating process;

FIG. 11 is a flow chart showing the flow of process example of a file requesting process;

FIG. 12 is a flow chart showing the flow of process example of a file request processing process;

FIGS. 13a and 13b are explanatory diagrams showing an example of a directory information initializing process.;

FIGS. 14a and 14b are explanatory diagrams showing an example of a process of sending a file request to other nodes;

FIG. 15 is an explanatory diagram showing an example of a directory information updating process due to the notice of file addition or deletion from other nodes;

FIG. 16 is an explanatory diagram showing an example of a directory information re-initializing process.

### DETAILED DESCRIPTION OF THE PREFERRED EMBODIMENT

A preferred embodiment of the present invention will be explained below referring to the drawings.

### (Overall Configuration of a Network)

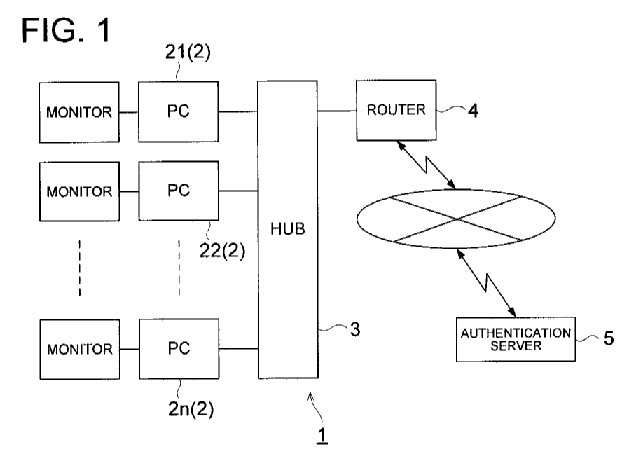

FIG. 1 is a diagram showing an example of the overall configuration of a network 1. Regarding the preferred embodiment of a network which functions as a system for managing directory information according to an embodiment of the present invention, its overall physical configuration will be explained referring to FIG. 1

The network 1 according to the preferred embodiment of the present invention, as shown in FIG. 1, is a LAN (Local Area Network) configured from nodes such as a plurality of terminal devices 2 (21, 22, . . . , 2n), a switching hub 3, router 4, and an authentication server 5. These terminal devices 2 are connected in a star configuration to the switching hub 3 by twisted pair cables.

The terminal devices 2 functioning as the nodes constituting the network are information processing apparatuses, and are apparatuses that carry out data input and output processing with other apparatuses such as personal computers, workstations, or printers. In the following, nodes simply refer to these terminal devices, and the explanations will be given assuming that personal computers are used as the information processing apparatuses.

Further, in the present preferred embodiment, a communication network form called P2P (Peer to Peer) has been used. P2P is a network usage form in which information is exchanged directly between an unspecified number of nodes, and there are the two types of P2P, one requires mediation by a central server and the other carries data in the bucket brigade manner. Even when a central server is required, the central server is only carrying out the functions of providing a file search data base and managing the connections between the nodes, and the exchange of data itself is done by the direct connection between nodes.

Further, the bucket brigade manner is employed, there are two cases, in one case the communication is made only between the nodes that are physically neighboring, and in the other case the communication is made only between nodes that are neighboring each other in the connection relationship defined logically which is different from the physical connections. The latter is called an overlay network.

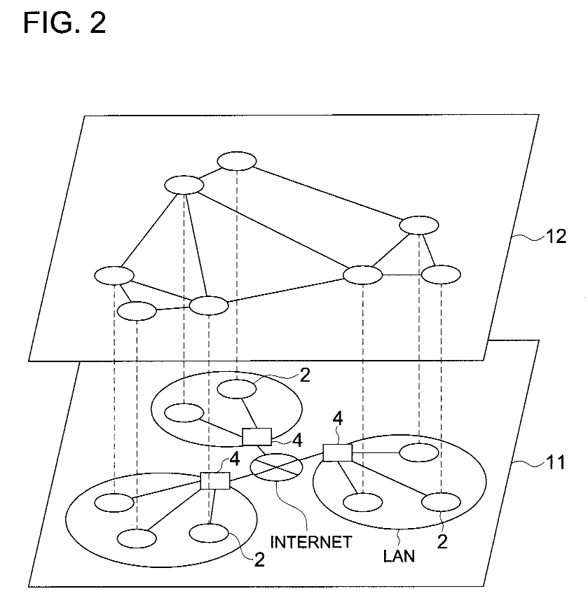

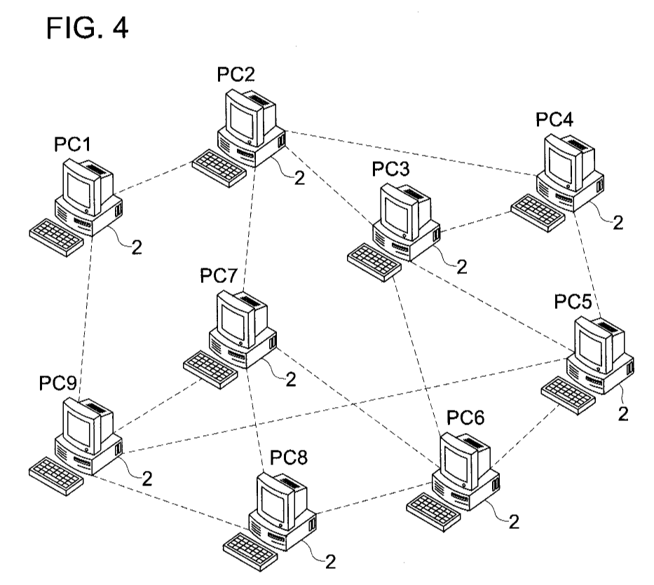

FIG. 2 is diagram showing schematically a structure of the overlay network. The numeric symbol 11 in this figure shows a physical connection relationship between the nodes, and the numeric symbol 12 shows a logical connection relationship. Further, FIG. 1 described earlier illustrates the physical connection relationship, while FIG. 4 to be explained later illustrates the logical connection relationship. The nodes in the network have these two types of relationships at the same time.

In the present preferred embodiment, direct logical connections are made mutually between all the nodes 2, and they can communicate with any other node (hereinafter referred to as a connection form 1). Further, the connection topology of FIG. 4 will be explained later to give consideration to another connection form (hereinafter referred to as a connection form 2) where a direct connection is made to communicate between the nodes 2 (terminal devices) which are associated with each other beforehand, and a connection with the nodes which are not associated beforehand is made via the directly connected nodes.

The authentication server 5 carries out only the management related to the certificate for authentication, and does not directly deal with the connection for communication. Further, the router 4 carries out only the relaying of communication between nodes (terminal devices), and does not get directly involved in the control of permitting or rejecting those connections.

A part or all of the nodes 2 constituting the network have the directory information indicating the correspondence of which of the nodes has which of the files stored in the network (hereafter, the nodes retaining the directory information are referred to as the “First nodes” for the sake of convenience). In addition, each of all the nodes 2 has a file list as the list information of the files stored in itself (hereafter, for the sake of convenience, the nodes retaining file lists are referred to as the “Second nodes”). The nodes 2 retaining both the directory information and the file list are first nodes and second nodes at the same time, and it is also possible that all the nodes are first nodes and second nodes.

In the following, in a network carrying out management of the directory information according to the present preferred embodiment, explanation is given below about the management of files by using directory information, particularly about the case in which various processes are made for the sake of updating directory information.

### (Configuration of Node)

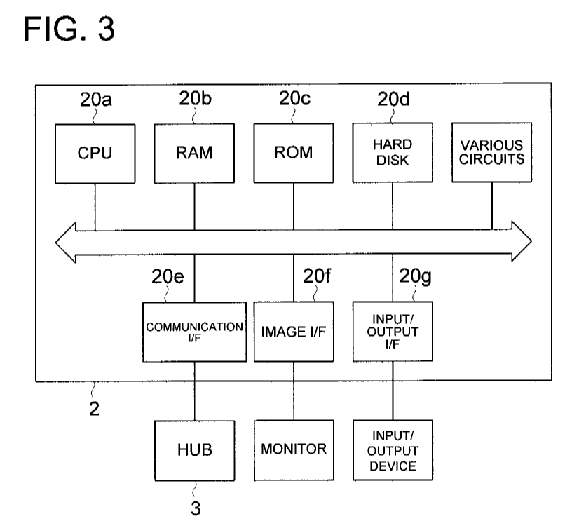

FIG. 3 is a diagram showing an example of the hardware configuration of the node (terminal device) 2 that constitutes the network 1.

The terminal device 2, as shown in FIG. 3, is configured to have a CPU 20a, a RAM 20b, a ROM 20c, a hard disk 20d, a communication interface 20e, an image interface 20f, an input/output interface 20g, and other different types of circuits or devices.

The communication interface 20e is, for example, a Network Interface Card (NIC), and is connected via a twisted pair cable to one of the ports of the switching hub 3. The image interface 20f is connected to a monitor, and transmits video signals to the monitor for displaying images.

The input/output interface 20g is connected to input devices such as a keyboard, or a mouse, and to an external storage device such as a CD-ROM drive. Further, the input/output interface 20g inputs the signals indicating the contents of the operations on the input device made by the user from the input device, or it makes an external storage device read the data recorded in a recording medium such as a CD-ROM in order to input the data, or it outputs the data to be written into the storage medium to the external storage device.

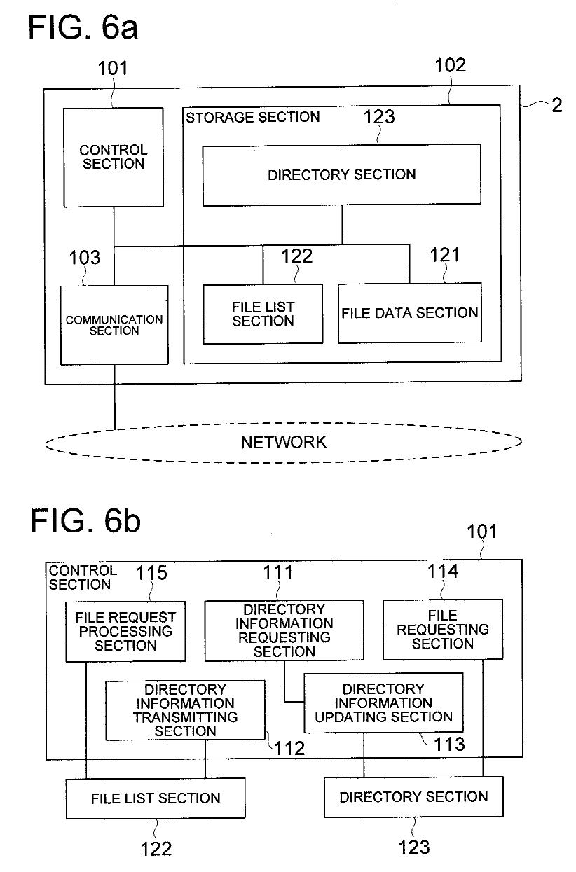

Although explanation will be given later using the functional block diagrams (FIGS. 6a and 6b), in the hard disk stored are the various programs for realizing the functions of the control section 101, for example, a request section such as a directory information requesting section 111, a transmission section such as a directory information transmitting section 112, an updating section such as a directory information updating section 113, a request section such as a file requesting section 114, file request processing section 115, etc. In addition, provided are storage areas, for example, a second storage section or a file storage section such as a file data section 121, a file list section 122, a first storage section or a directory storage section such as a directory section 123, and data are stored in these sections. These programs and data are read into the RAM 20b when required, and the programs are executed by the CPU 20a.

A host name (machine name), an IP address, and a MAC address are assigned to each node 2 so as to distinguish it from the other nodes 2. The host name can be assigned freely by, for example, an administrator of the network 1. The IP address is assigned according to the rules of the network 1. The MAC address is an address fixedly assigned to the communication interface 20e of that node 2.

In the present preferred embodiment, it is assumed that the host names such as “PC1”, PC2” . . . are assigned a to each of the nodes (terminal devices) 21, 21 . . . . In the following, these nodes 2 may be called by their host names.

### (Connection Form of Nodes)

FIG. 4 is a diagram showing an example of the connection form of each of the nodes 2 constituting the network 1, in other words, the logical topology of nodes. The connection form 2 of the nodes (terminal devices) mentioned earlier is explained here using FIG. 4.

The aforementioned connection form 1 can be considered as the configuration where all nodes are assumed to be directly connected with each other in the following explanation. Although it will be explained later, the difference between the connection form 1 and the connection form 2, in other words, the difference between the direction connection and the indirect connection, appears as the difference in the loads on the network caused by the same volume of traffic.

As shown in FIG. 4, the nodes 2 are assumed to be placed in a virtual space. Thus, as shown by the broken lines, each of the nodes is associated with at least one other node 2 in the neighborhood in the virtual space. In addition, because of these associations, all nodes 2 are associated with each other either directly or indirectly.

Further, “directly associated” means that the two nodes are connected by a single broken line in FIG. 4 (for example, a relationship between the PC1 and the PC2 or the PC9 in FIG. 4), and “indirectly associated” means that the two nodes are connected through two or more broken lines and one or more other nodes between them (for example, the relationship between the PC1 and the PC4 in FIG. 4). The node 2 transmits data directly to other nodes that are directly related to it.

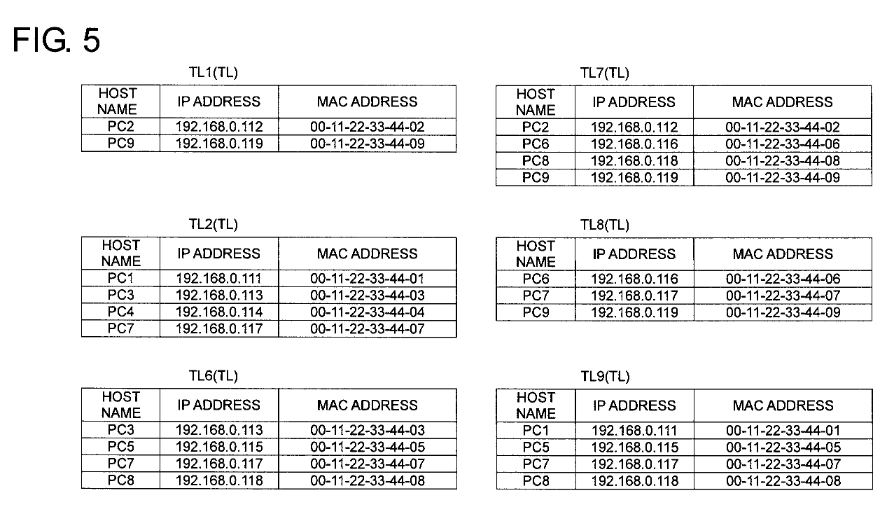

FIG. 5 is a diagram showing an example of the connection table TL of the nodes 2 which are associated as shown in FIG. 4. Each node 2 has a list of the information, as a table, for connecting with the other nodes 2 which are “directly associated” and to which a direct data transmission is possible.

For example, for the PC1, PC2, PC6, PC7, PC8, and PC9 in FIG. 4, connection tables TL1, TL2, TL6, TL7, TL8, and TL9 as shown in FIG. 5 are held.

Further, the processes for the management of the directory information to be described later are explained without making any distinction between the connection form 1 and the connection form 2. These two will be described separately only regarding the adjustment of the communication traffic caused by the differences between the communication form 1 and the communication form 2.

### (Functional Configuration of Nodes)

FIG. 6a and FIG. 6b are block diagrams showing an example of the functional configuration of the nodes 2 (terminal devices) related to the file management using the directory information. The processing function of each section of the nodes 2 will be described using FIGS. 6a and 6b.

In FIG. 6a, the node 2 is provided with a control section 101, a storage section 102, and a communication section 103.

The control section 101 is a functional block that is realized using a processing unit (CPU), a memory storing programs, and a memory for temporarily storing data. The processing functions based on the operation of the programs will be described later referring to FIG. 6b. Each process operates in a multitasking mode.

The communication section 103 is realized with an interface with the network and buffer memory for transmission and reception. The communication section 103 carries out transmission and reception of the required data with other nodes in accordance with the processes executed by the control section 101.

The storage section 102 is realized with a nonvolatile memory such as a hard disk or a flash memory and their control devices. The storage section 102 has the following storage areas.

The file data section 121 that stores the data constituting the file that is held by the node, the file list section 122 that stores the list of the files held by the node, and the directory section 123 in which the list of all the files held by all the nodes in the network (including the relationship with the node possessing each of these files) is stored. However, the directory section 123 is provided only in the first nodes that store the directory information.

The stored data in each of these storage areas are referred to, added to, or deleted appropriately according to the processes executed by the control section 101.

FIG. 6b is a diagram showing the internal configuration of the functions executed by the control section 101. The functions of the control section, in other words, the processing functions, referring to directory information, such as file acquisition from other nodes or updating and management of the directory information itself will be described using FIG. 6b.

The processing functions of the control section 101 include the directory information requesting section 111, directory information transmitting section 112, and the directory information updating section 113.

The directory information requesting section 111 carries out inquiry of the file list for updating the directory information. The directory information transmitting section 112 transmits the file list in response to a request for the file list. The directory information updating section 113 updates the directory information according to the file lists received from other nodes.

Further, the processing functions of the control section 101 includes the file requesting section 114 that searches the node possessing the file to be acquired, and the file request processing section 115 that carries out file transmission, etc., according to the file request.

The details of the function of each section in the control section 101 are described along with the following descriptions of the processes for management.

### (Various Processes for Management)

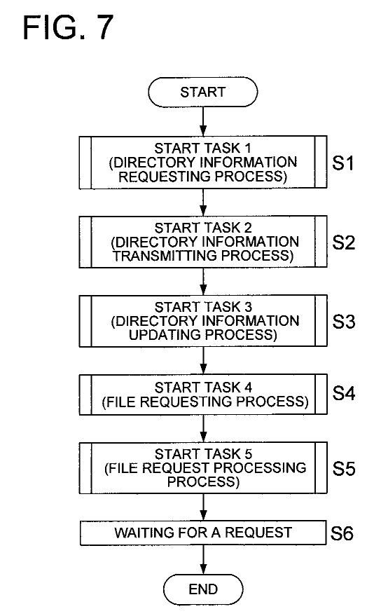

FIG. 7 is a flow chart showing the flow of the steps which activate the processes necessary for the file management using the directory information and the management of the directory information. The outlines of the processes of the processes for the management will be described below using FIG. 7.

In FIG. 7, five types of tasks (Task 1 to Task 5) are started (Step S1 to Step S5) for the file management using the directory information and the management of the directory information.

These tasks are running in a multitasking mode, in other words, they are in the state of being concurrently active, and the respective tasks are in the state of waiting for a request from the clients or from other nodes (Step S6).

The control section 101 is provided with the execution sections each of which deals with each process of each task, and the control section 101 is provided with a queue (buffer) for temporarily storing the process requests. The tasks carry out the respective operations in accordance with the occurrence of requests for each process.

These tasks cooperate with each other to execute the following processing operations.
a. Initialization of directories (Tasks 1, 2, and 3)
b. File request processing (Tasks 4 and 5)
c. Directory updating based on notice (Tasks 4 and 3)
d. Re-initialization of directories (Tasks 1, 2, and 3)
The details of these processes will be described later.

The processes executed by these tasks will be explained in the following.

### <Task 1: Directory Information Requesting Process>

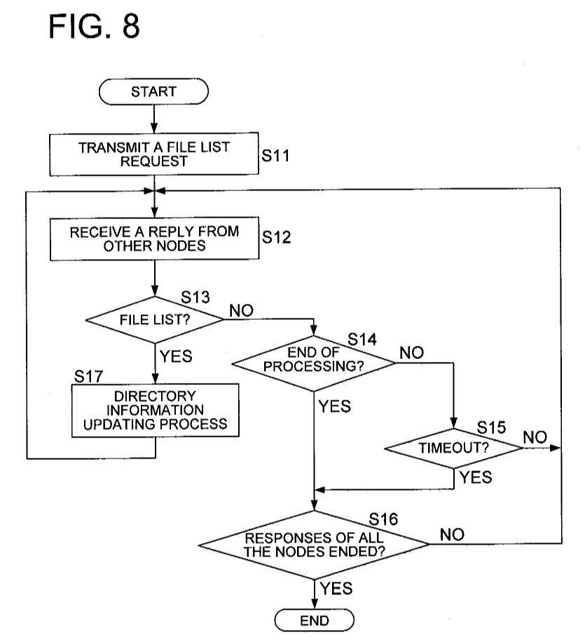

In Task 1, the directory information requesting section 111 executes the directory information requesting process. FIG. 8 is a flow chart showing the flow of an example of processing of the directory information requesting process.

In the directory information requesting process, the processing is started not due to a request from other nodes but due to an instruction from the client or at a set timing. The process is sending a file list request to other nodes in order to update the stored directory information.

Therefore, this is the process that is executed only by the first node having the directory information, and the file list request is sent to all the second nodes.

In FIG. 8, in Step S11, requests are transmitted to the other nodes (the second nodes) for the file list which is the information of the list of the files stored in respective nodes.

Further, in some cases, the request may be transmitted with the information for determining the priority of the file list or with the condition for determining priority. As described later, this is for specifying the order of transmission with considering the delay due to the adjustment of the communication traffic.

In Step S12, firstly, a reply of the acceptance of the request (Task 2, Step S22 described later) is received. This makes it possible to identify the node from which the first node receives the file list. After that, the file list is succeedingly received (usually this is divided into several parts), and finally, a reply for noticing the end of the requesting process is received.

In Step S13, a judgment is made as to whether or not the reply (Task 2, Step S24 or Step S27) of the file list was received. When the reply is a part of the file list (YES in Step S13), the directory information updating process of Step S17 (Task 3, details are explained later) is executed, and the next replay is awaited by returning to Step S12. If the reply is not a part of the file list (NO in Step S13), Step S14 is executed.

In Step S14, a judgment is made as to whether or not the reply is a reply for noticing the end of the requesting process from that node (Task 2, Step S28 described later). If it is a reply for noticing the end of the requesting process (YES in Step S14), the operation proceeds to Step S16. If the reply is not a reply for noticing the end of the requesting process (NO in Step S14), the operation proceeds to Step S15.

In Step S15, a judgment is made as to whether or not a timeout occurs. If the timeout occurs (YES in Step S15), Step S16 is carried out. If the timeout does not occur (NO in Step S15), the operation returns to Step S12 and waits for the next reply.

In Step S16, a judgment is made as to whether or not the responses ended in all the nodes to which the file list requests were sent, in other words, whether or not replies for noticing the end of the requesting process were received from all the nodes that accepted the file list requests. If all the responses of the nodes have ended (YES in Step S16), this process is ended. If not all the responses of the nodes have ended (NO in Step S16), the process exceeds to Step S12 and waits for the next reply.

When this routine ends, the file lists of all the nodes in the network have been received, and based on that, all the directory information has been updated. In other words, all the directory information has been updated with the latest file storing states reflected.

### <Task 2: Directory Information Transmitting Process>

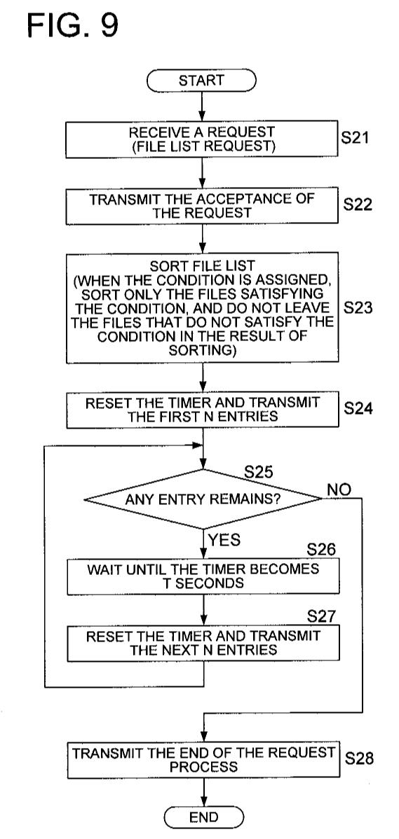

In Task 2, the directory information transmitting section 112 executes the directory information transmitting process. The flow chart of the directory information transmitting process is shown in FIG. 9.

In the directory information transmitting process, the process is started in response to the file list request (Task 1, Step S11) from other nodes (the first nodes) in the directory information requesting process described earlier.

Consequently, this process is executed by all the second nodes upon receiving the request, and the file list is transmitted for updating the directory information of the requesting nodes (the first nodes).

The transmitted file list will have considerable volume of data depending on the number of files stored in the node. In addition, since the transmission is made almost simultaneously from all file-storing nodes (the second nodes) to a particular node (a first node), the network traffic increases and becomes an excessive load if the transmission is executed normally.

In the present preferred embodiment, at the time of transmitting the file list, the intervals of transmitting the divided file list are adjusted so that the time average traffic does not exceed a predetermined value. Because of this, the communication traffic is suppressed for other more important operations thereby making sure that those other operations are not delayed or disturbed.

In FIG. 9, firstly in Step S21, a request for the file list (Task 1, Step S11) for updating the directory information is received from the requesting node (a first node), and this causes the following steps of this process to start. Further, in some cases, along with the file list request, the information for determining the priority of the list or the condition for determining priority are also received. This is for assigning the order of transmission in consideration of some delay due to the abovementioned adjustment of the communication traffic.

In Step S22, firstly, a reply of a request acceptance is transmitted. With this, the requesting source can identify the correspondent node that will be sending the file list.

In Step S23, the file list is sorted. Based on the condition for determining priority received along with the above file list request, or based on the conditions that have been set beforehand, sorting is made while assigning priority to the file items of the list. In addition, in some cases, the file items that do not match the conditions may not be remained in the result of sorting.

Because of the above sorting operation, the file list can be successively transmitted according to the priority with the communication traffic restricted. More details of the sorting operation are described later.

In Step S24, in order to control the intervals of transmission periods, in addition to resetting a timer, the first N entries (the file items of the file list, also referred to as entries hereafter) are sent to the requesting source according the priority of the result of the abovementioned sorting.

In Step S25, a judgment is made as to whether or not there are entries that have not yet been transmitted. Step S26 is executed if there are any entries remaining (YES in Step S25). If there are no entries remaining (NO in Step S25), Step S28 is executed, end of the request process is transmitted, and this process is ended.

In Step S26, until the timer becomes T seconds, the transmission of the next entries is kept pending. As has already been explained, this is to make sure that the time average traffic does not exceed a prescribed value, according the prescribed value, the relationship between the number N of entries to be transmitted and the transmission time interval T seconds is determined. The details of this setting are explained later.

In Step S27, since T seconds have elapsed since the previous transmission, the next N entries are sent to the requesting source after resetting the timer.

After that, the operation returns to Step S25, and until there are no more entries remaining (NO in Step S25), the operations from Step S25 to Step S27 are repeated. When there are no more entries remaining, the end of the request process is transmitted in Step S28, and this process is ended.

When this process ends in all the nodes (the second nodes), the file lists of all the nodes of the network have been transmitted to the requesting first node, and based on these, the directory information can be all updated.

Further, during the process of transmitting the file list, since the time average traffic is being suppressed by adjusting the transmission time intervals as described above, it is possible to eliminate bad effects such as delaying or bothering other more important processing operations such as file transfer, etc.

### <Task 3: Directory Information Updating Process>

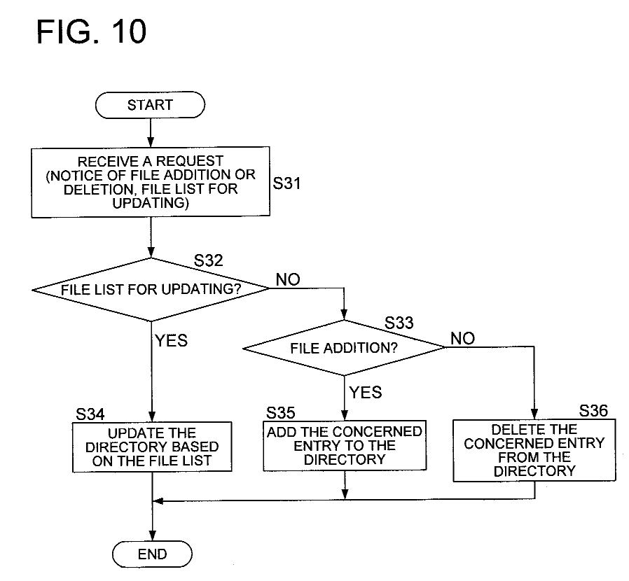

In Task 3, the directory information updating section 113 executes the directory information updating process. The flow chart of the directory information updating process is shown in FIG. 10.

In the directory information updating process, the process is started upon acquiring the file lists in the directory information requesting process (Task 1: Step S17) described earlier.

Therefore, this process is executed by the first node that has requested file lists for updating the directory information and that has received the file lists, and the directory information is updated based on the received file lists.

Further, in this directory information updating process, the directory information updating process is started also in the case in which a posting of addition or deletion of files is received from a scone node possessing files (Task 4, Step S46 or Step S47 to be described later). In that case, this process is executed for updating the directory information upon receiving the notice of file addition or deletion, and the directory information is updated based on that notice.

In FIG. 10, firstly in Step S31, the processes following this step are started when a first node receives the file lists for updating the directory information (Task 1, Step S17), or it receives a notice of file addition or deletion (Task 4, Step S46 or Step S47 to be described later).

In Step S32, a judgment is made as to whether or not what has been received is a file list for updating the directory information. If what has been received is a file list (YES in Step S32) then Step S34 is executed. If what has been received is not a file list (NO in Step S32) then Step S33 is executed.

In Step S34, based on the file list, the directory information in the directory section 123 is updated. With this, this process ends and the next request (file list) will be awaited.

In Step S33, a judgment is made as to whether what has been received is a file addition notice or otherwise (notice of deletion). If it is the notice of file addition (YES in Step S33), Step S35 is executed. If it is the notice of file deletion (NO in Step S33), Step S36 is executed.

In Step S35, based on the posting of file addition, the concerned entry is added to the directory information in the directory section 123.

In Step S36, based on the notice of file deletion, the concerned entry is removed from the directory information in the directory section 123.

With this, this process ends and the next request (notice of file addition or deletion) will be awaited.

When this process ends, the directory information can be updated based on the file list or the notice of file addition or deletion. In other words, it is possible to reflect the latest file storing status.

### <Task 4: File Requesting Process>

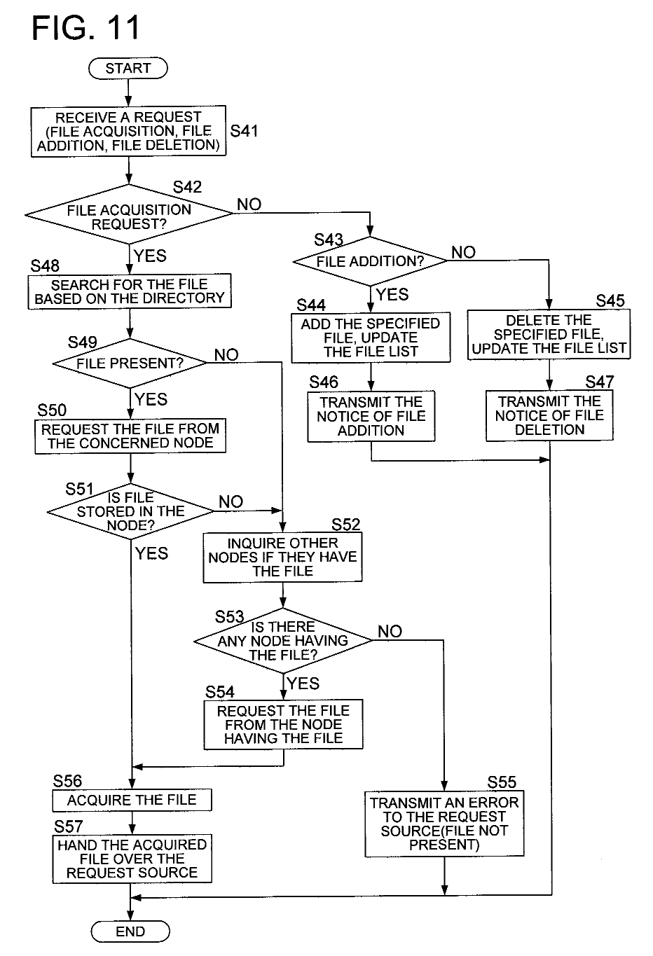

In Task 4, the file requesting section 114 executes the file requesting process. FIG. 11 is a flow chart showing the flow of the process of the file requesting process.

In the file requesting process, the process is started in response to a file acquisition request from the client (the operator of that node) or from another node, or in response to a request for file addition or deletion.

Therefore, this process is executed by a second node storing a file, and carries out addition or deletion of a stored file, or by referring to the directory information of a first node, searches the node storing the target file, accesses that node, and acquires the file.

In FIG. 11, firstly in Step S41, this process starts upon receiving from another node or from the client a request for file acquisition, file addition, or file deletion.

In Step S42, a judgment is made as to whether the request is a file acquisition request or not. If it is a file acquisition request (YES in Step S42), Step S48 is executed. If it is not a file acquisition request (NO in Step S42), Step S43 is executed.

In Step S43, a judgment is made as to whether the request is a file addition request or not (file deletion request). If it is a file addition request (YES in Step S43), Step S44 is executed. If it is a file deletion request, Step S45 is executed.

In Step S44, based on the request of file addition, the specified file is added to the file data section 121 by the control section 101 as a list generation section, and the entry is added to the list in the file list section 122. After that, in Step S46, the notice of file addition is transmitted to the first node having the directory information. With this, this process ends (waiting for the next request).

In Step S45, based on the request of file deletion, the specified file is removed from the file data section 121, and also the entry is removed by the control section 101 as a list generation section from the list in the file list section 122. After that, in Step S47, the notice of file deletion is transmitted to the first node having the directory information. With this, this process ends (waiting for the next request).

On the other hand, in Step S48, in response to a file acquisition request, a first node having the directory information is accessed, the directory information in the directory section 123 is referred to, and the node storing the file to be acquired is searched. However, in case that the node itself is a first node retaining directory information, the reference is made to the directory section 123 of its own.

In Step S49, a judgment is made as to whether or not the target has been found. If the file is present (YES in Step S49), Step S50 is executed. If the desired file is not present (NO in Step S49), Step S52 is executed.

In Step S50, the node having the target file that was found by the search is accessed and a file request is made.

In Step S51, a judgment is made as to whether or not the file is stored in that accessed node. If the file is stored (YES in Step S51), Step S56 is executed. If the file is not stored (NO in Step S51), the operation proceeds to Step S52.

In Step S52, since the target file cannot be found, the other nodes (all the second nodes) are accessed and an inquiry is made as to the storage of the file.

In Step S53, based on the response from each node (Task 5, Step S67 or Step S68 to be described later), a judgment is made as to whether or not there is a node storing the target file. If there is a node storing the target file (YES in Step S53), Step S54 is executed. If there is no node storing the target file, the operation proceeds to Step S55.

In Step S54, the node storing the desired file that was found by the search is accessed and a file request is made.

In Step S56, the file is received to be acquired from the node from which the file is requested (Task 5, Step S65 to be described later). Next, in Step S57, the acquired file is handed over to the requesting source, and this process is ended (waiting for a request). If the requesting source is the client, the file is displayed, and if the requesting source is another node, then the file is transmitted to that node.

Further, in Step S55, since the target file is not found in any node, an error indicating that there is no such a file is transmitted to the source of the file request (an error display is made if the requesting source is the client), and this process is ended (waiting for a request).

### <Task 5: File Request Processing Process>

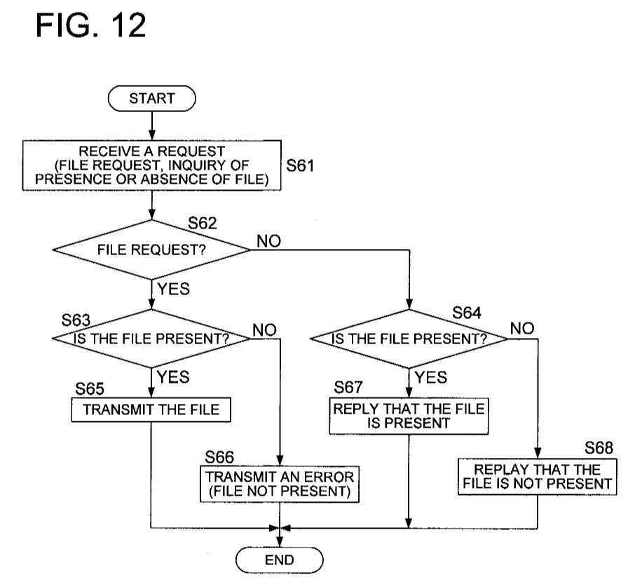

In Task 5, the file request processing section 115 executes the file request processing process. FIG. 12 is a flow chart showing the flow of the file request processing process.

In the file request processing process, the process is started in response to a file request from other nodes (Task 4, Step S50, Step S54), or to an inquiry of the presence or absence of a target file (Task 4, Step S52) from other nodes.

Therefore, this process is executed by a second node having a file, and the stored file is transmitted according to the file request. Or else, in response to an inquiry of presence or absence of a target file, a reply of whether or not it has that file is transmitted.

In FIG. 12, firstly in Step S61, this process is started in response to a file request or an inquiry of the presence or absence of a specified file from other nodes.

In Step S62, a judgment is made as to whether the request is a file request or not (an inquiry of presence or absence of a file). If it is the file request (YES in Step S62), Step S63 is executed. If it is the inquiry of the presence or absence of a file (NO in Step S62), Step S64 is executed.

In Step S63, a judgment is made as to whether or not the requested file is stored in that node. If the file is stored (YES in Step S63), Step S65 is executed, and the file is transmitted to the requesting source. If the file is not stored (NO in Step S63), Step S66 is executed, and an error indicating that the file is not present is sent to the source node of the request.

In Step S64, in response to the inquiry of the presence or absence of a file, a judgment is made as to whether or not the target file is stored in that node. If the file is stored (YES in Step S64), Step S67 is executed, and a reply indicating the presence of the file is transmitted to the requesting source. If the file is not stored (NO in Step S63), Step S68 is executed, and an error indicating that the file is not present is sent to the requesting source node.

With this, this process is ended (waiting for a request).

### (Management of Directory Information)

The process of the management of the directory information, and the file management process that uses the directory information are explained here. The following processes are executed by the operations of the aforementioned tasks in cooperation with each other.

### <Initialization of Directory>

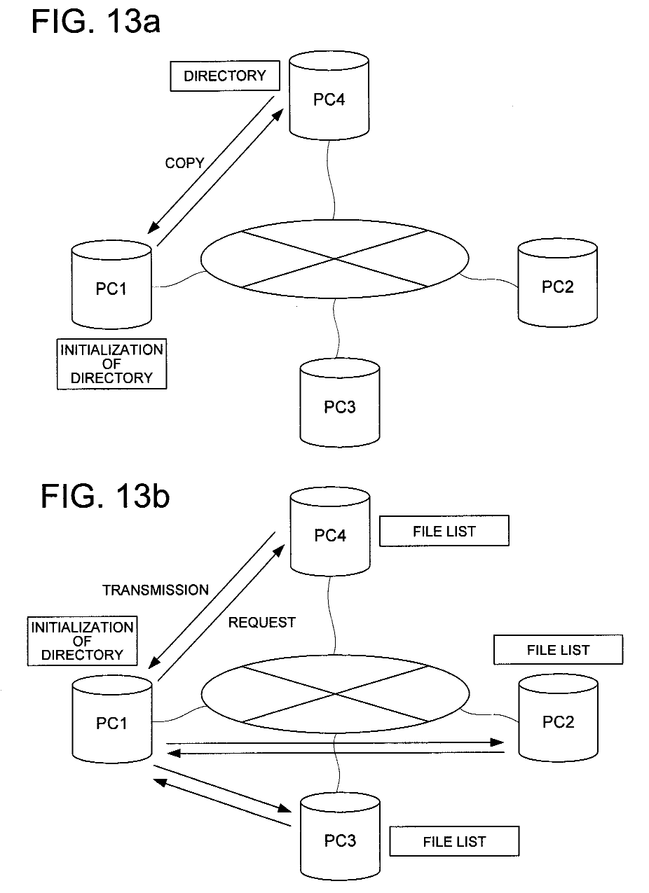

FIGS. 13a and 13b are explanatory diagrams showing an example of the directory information initializing process. Using FIGS. 13a and 13b, the process of initialization of the directory information in the first node is explained here.

In the following description of the initialization process, it is assumed as a starting point that the directory section 123 (FIGS. 6a and 6b) has no entry point as directory information in such a case that a certain first node is participating in the network system for the first time.

In this case, two types of directory information initialization processes are mainly considered to be employed.

One of these is the case that there is another first node that already has the directory information. In this case, it is possible to use a method of initialization in which the node that already has the directory information is searched out and accessed in order to copy the directory information as the initial condition of the directory. This is shown in FIG. 13a.

In FIG. 13a, the first node PC1 requests the directory information from another first node PC4 that already has the directory information, and receives a copy of the directory information from the PC4. The node PC1 initializes the directory by merely storing that directory information in its own directory section 123.

However, it is not guaranteed that the copied directory information is storing the entries for all the files present in the entire system. It is necessary for the latest file storing statuses in the entire system to be quickly reflected in the directory information.

The other type of directory information initialization method is the method of inquiring all the nodes in the network system for the file lists of the files stored by those nodes. This is shown in FIG. 13b.

In FIG. 13b, the node PC1 requests from the nodes PC2, PC3, and PC4 for their file lists, and receives the replies of the file lists from the respective nodes. Based on these file lists, the node PC1 initializes the directory by successively adding them to its own directory. Since the file list from each of the nodes is transmitted being divided into pieces, the reception is made repeatedly until the end of the request processing is received from each node.

The initialization of the directory is achieved with these procedures executed as follows: the PC1 which is a first node executes Task 1 (directory information requesting process); the PC2, PC3, and PC4 which are second nodes that have received the file list request execute Task 2 (directory information transmitting process); and based on the file lists that have been transmitted, Task 3 (directory information updating process) is executed in the PC1 which is a first node.

### <File Requesting Process>

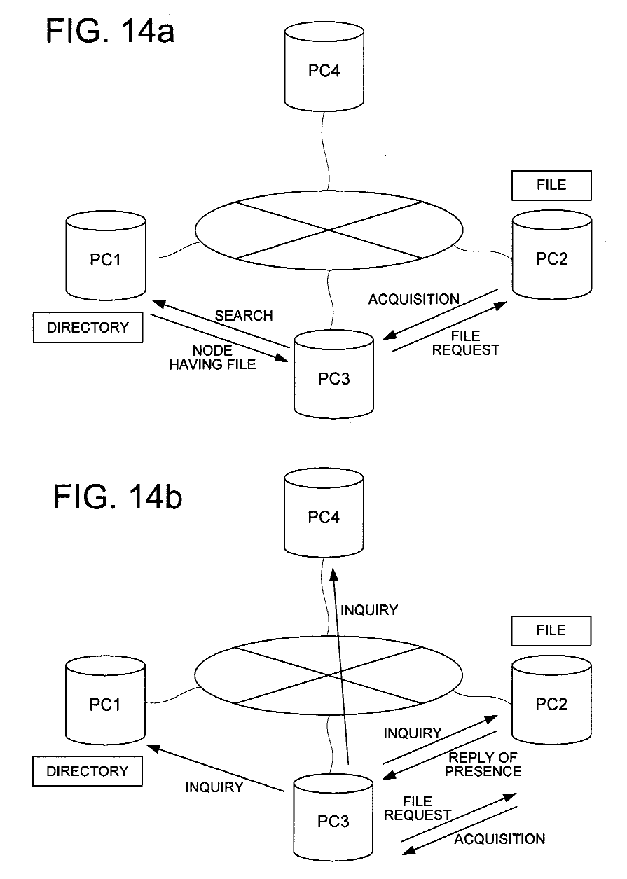

FIGS. 14a and 14b are explanatory diagrams showing an example of the process of sending a file request from other second nodes for the files stored in those nodes. Referring to FIGS. 14a and 14b, the process of making file requests to the other second nodes is explained below.

In a network system in which files are distributed and shared, the file requesting process is primarily important for using files, and it is a basic of the process to search for the node having the target file. The directory information stored in the first nodes is used for this purpose.

FIG. 14a shows how this is done. In FIG. 14a, the second node PC3 accesses the first node PC1 that has the directory information, and searches for the node having the target file by referring to the directory information thereof. The PC3 obtains from the PC1 the information about the node having the target file (node PC4), sends a file request to the PC4, and acquires the target file from the PC4.

This procedure is executed as follows: Task 4 (file requesting process) is executed in PC3 which is a second node, in response to the file request sent to node the PC2 which was searched out as the node having the file by referring to the directory information of a first node the PC1; Task 5 (file request processing process) is executed in the PC2; and the specified file is transmitted to the PC3.

If the entry of the target file is not present in the referred directory, or if the node that was accessed by referring to the entry in the directory does not have the file, there is a method of sending an inquiry to all the nodes in the network system asking if they have the target file, and sending a file request to the node that has the target file based on the replies to these inquiries. FIG. 14b shows how this is done.

In FIG. 14b, the node PC 3 which failed to find out the node having the target file by merely referring to the directory information of the first node PC1 has sent inquires to the other second nodes PC2, PC4 and PC1 asking if they have the target file, and is receiving replies from these nodes. The reply from the PC2 is that it has the file, and based on that reply, the PC3 has sent a file request to the PC2, and has acquired the target file from the PC2.

This procedure is executed as follows: Task 4 (file requesting process) is executed in the PC3 which is a second node, in response to the file request sent to the node PC4 which was searched out as the node having the file by referring to the directory information of the first node PC1; Task 5 (file request processing process) is executed in the PC2, PC4, and PC1, based on the replies from them; and the file request is transmitted from the PC3 to the PC2 which is the node having the file.

### <Directory Information Updating Based on Notice>

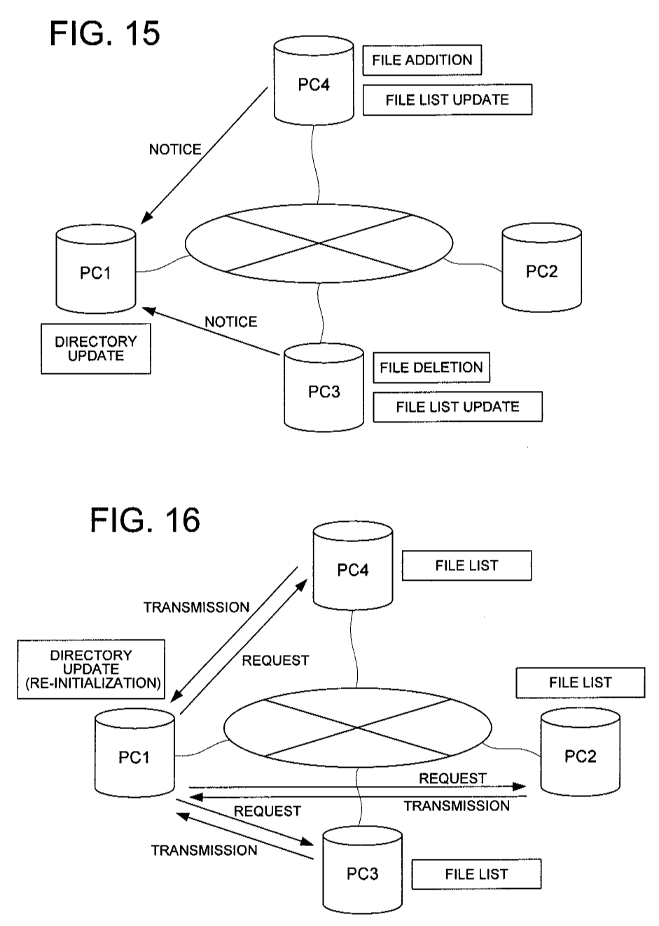

FIG. 15 is an explanatory diagram showing an example of the directory information updating process in the first node based on the notice of file addition or deletion from other nodes. Referring to FIG. 15, the directory updating process in the first node based on the notice from other nodes is explained below.

In the directory updating process based on the notice, the first node having the directory information updates the directory information upon receiving the notices of file addition or deletion from other nodes in order to reflect the latest file storing status of each node in the network system to the entries in the directory information in the directory section 123.

FIG. 15 shows how this is done. In FIG. 15, the second node PC4 has been added a file and has updated the file list. At the same time, it has sent to the first node PCl the notice stating that it has added a file. Further, the second node PC3 has deleted a file and has updated the file list. At the same time, it has sent to the first node PC1 the notice stating that it has deleted a file.

The first node PC1 is updating the directory information based on the notice from the second node PC4 that it has added a file, and based on the notice from the second node PC3 that it has deleted a file. In other words, in its directory section 123, it adds an entry corresponding to the file noticed by the PC4 and also deletes the entry corresponding to the file noticed by the PC3.

This procedure is executed as follows: Task 4 (file request process) is executed in the second nodes the PC3 and PC4 in accordance with the addition or deletion of a file; the first node PC1 executes Task 3 (directory information updating process) upon receiving the notice of file addition and deletion transmitted to it; and based on the received notice, updating of the directory information is achieved.

### <Re-initialization of Directory>

FIG. 16 is an explanatory diagram showing an example of the process of re-initializing the directory information in the first node. Using FIG. 16, the process of re-initializing the directory information in the first node is explained below.

In the re-initializing process, re-initializing of the directory information stored in the first node is executed, and a process similar to the initialization process described earlier is executed.

It is necessary that the directory information stored in the first node always reflects the latest file possession statuses, and hence, the directory updating process based on the notice from other nodes is carried out as explained earlier. In other words, by updating the directory information upon receiving the notice every time there is a change in the file storing status, the directory information is able to reflect the latest file storing status.

However, due to various circumstances the directory information may need to be re-initialized in such a case that the directory updating process based on the notice does not function normally.

A first node having directory information carries out re-initialization of the directory when situations such as those described below occur. a. When the first node is attached to the network after a set time of detach from the network, or when the network is recovered after the network is detected to be down. b. When it is detected that the following occasion occurs more frequently than the set value. The occasion is that the node accessed based on the directory information does not have the target file. c. When there is an instruction from the user.

The re-initialization of the directory is done, similar to the initialization process, by a first node inquiring all the other nodes in the network system for the file lists of all the files stored in the respective nodes. Each of the transmitted file lists is successively added to its own directory, thereby carrying out the re-initialization of the directory.

FIG. 16 shows how this is done. In FIG. 16, the first node PC1 requests the nodes PC2, PC3, and PC4 for their file lists. It receives the transmitted file list from each of these nodes. Based on these file lists, the node PC1 carries out the re-initialization of the directory by successively adding to and updating its own directory. Since the file list from each of the nodes is transmitted being divided into pieces, the reception is made repeatedly until the end of the request process is received from each node.

This procedure is executed as follows to achieve the re-initialization of the directory: the PC1 which is the first node executes Task 1 (directory information requesting process); the PC2, PC3, and PC4 which are the second nodes that have received the file list request execute Task 2 (directory information transmitting process); and based on the file lists that have been transmitted, Task 3 (directory information updating process) is executed in the PC1 which is the first node.

### (Process Flow of File List Transmission)

In the distributed file sharing network system according to the present preferred embodiment, each of all the nodes may has a plurality of files. Because of this, even during initialization of the directory, and also during re-initialization of the directory, all the nodes in the network may transmit the file lists each having a plurality of files almost at the same time.

This increases the network traffic, reduces the performance, and disturbs or delays other more important processes such as a file request or its process.

Referring to FIG. 9, as explained regarding the directory information transmission process, in the present preferred embodiment, at the time of transmitting the file list divided into pieces from each of the nodes, the time average traffic is made not to exceed a prescribed value by adjusting the intervals between the transmissions of the divided file list.

Further, the file list is transmitted with the traffic being restricted by sorting the file list according to the assigned priority. The priority is assigned based on the priority condition received along with the file list request. In addition, in some cases, the file items that do not match the condition do not remain in the result of sorting.

The file list sorting process (assigning priority for transmission) and the adjustment of the time average traffic during transmission will be explained as follows.

### <Sorting File Lists, and Priority Process>

In the directory information transmitting process, a file list is sorted before being transmitted (Step S23 in FIG. 9). As explained above, the purpose is to transmit successively according to the priority in a state in which the communication traffic is restricted.

There will be described sorting methods with different ways of assigning the priority.

### 1. Priority Determined in Advance

The priority is determined for each file item in advance. When the file list request is received, the file list is transmitted sequentially to the requesting source after the files are sorted based on that priority.

### 2. In the Order of Updating Date and Time, or in the Order of Access Date and Time

The date and time of preparation of the file or the date and time the file was last accessed is recorded in the files. When the file list request is received, the file list may be successively transmitted in a chronological order starting from the latest after the files are sorted based on the date and time. In addition, the file list may be transmitted in a chronological order from the latest after the files are sorted based on the recorded date and time at which the file was last accessed.

3. In the Order of the number of Accesses, in the Order of the Frequency of Accesses

The number of times the file was accessed is recorded in a counter in the file. When the file list request is received, the files are sequentially transmitted in a descending order of the number of access after the files are sorted according to the number of access recorded in the counter. Or else, not only the number of access but also the time of access is recorded, the files are sorted according to the frequency of access, and they are sequentially transmitted in a descending order of the frequency starting from the most frequently accessed one.

### 4. Assignment of Priority

At the time of requesting for file lists, a key item for sorting is specified as the information for determining the priority. The files are sorted based on that specified key, and they are sequentially transmitted according to the specified order. The key item can be the date and time of updating, the date and time of accessing, the frequency of accesses, and also the order of file names, the order of file sizes, or a combination of these items.

### 5. Assignment of Condition for Determining Priority

At the time of request for the file list, the condition for determining the priority for selecting the necessary files is assigned. The condition for determining the priority is for limiting the files to be sorted as well as for sorting the limited files according to the priority. In other words, only the files satisfying the specified condition of the priority are sorted according to the specified priority. Therefore, the files with a lower priority than the assigned condition for determining the priority are not included in the result of sorting.

The abovementioned sorting operation of assigning the order to the file makes it possible to select the entries to be transmitted in the priority order when the file list is transmitted. Even if the time average traffic is restricted, the file with higher priority can be preferentially transmitted.

### <Adjustment of the Time Average Traffic>

In the directory information transmitting process, at the time of transmitting the file list, the transmission is made while adjusting the time average traffic (Steps S24 to Step S27 in FIG. 9). In specific terms, N entries are transmitted in T seconds. Because of this, it is possible to suppress the time average traffic so that it does not exceed a prescribed value, and to prevent bad effects, which are caused by increased load on the network, on other processes such as file transfer.

The method of determining the abovementioned N and T for adjusting the time average traffic is explained below.

The number of nodes in the network is denoted by M and the volume of data per entry of the directory is taken as K bytes. Further, the average number of files stored in one node is taken as F.

In the following example, although the time average traffic allocated for file list transmission is taken to be a fixed value C, C may be varied depending on the traffic conditions of the network. For example, the value of C may be taken to be a maximum of 5 M bytes per second when the network is free, and may be suppressed to 1 M bytes per second when the network is busy.

### <<In the Case of Connection Form 1>>

In the following, an example is explained of the method of adjusting the communication traffic in the connection form 1 of nodes in the network. The connection form 1, as already explained, is the form of communication in which the communication between any pair of nodes is done by a direct connection between them.

1. When the worst case is assumed:

All the M nodes constituting the network have the directory information, and they are assumed to request from the other nodes for the file lists at an arbitrary timing.

If all the M nodes request the file lists from each other at almost the same time, since the communication traffic per unit time required for transmitting these file lists is M×M×K×(N/T), this have to satisfy the following condition taking the time average traffic allocated for file list transmission as C:

M×M×K×(N/T)≦C

Therefore, the following relationship holds good:

(N/T)≦C/(M×M×K)

For example, if M is taken as 100, K as 250 bytes, and C as 1 M bytes/second,

(N/T)≦1000000/(100×100×250)=0.4

In other words, as long as 4 entries are transmitted from one node to one node per every 10 seconds, the communication traffic of the network never exceeds the prescribed data volume (1 M bytes/second).

2. When a Sufficiently Small Frequency of File List Requests is Assumed:

All the M nodes constituting the network have the directory information, and they are assumed to request from the other nodes for the file lists at an arbitrary timing.

However, if it is considered that the frequency (Q times per second) of the file list requests made by one node is sufficiently small, and only the volume of data per unit time necessary for replying file lists for one file list request of one node is considered, since it becomes M×K×(N/T), the following condition has to be satisfied taking the time average traffic allocated for the file list transmission as C:

(N/T)≦C/(M×K)

For example, if M is taken as 100, K as 250 bytes, and C as 1 M bytes/second,

(N/T)≦1000000/(100×250)=40

In other words, as long as 40 entries are transmitted per second, the time average communication volume of the network will never exceed the prescribed data volume (1 M bytes/second).

Further, if it is considered that M nodes make file list requests respectively at a frequency of Q times per second, since the volume of data per unit time necessary for replying file lists becomes

Q×M×M×K×F

the ‘sufficiently small frequency’ needs to satisfy the following relationship:

Q×M×M×K×F≦C.

For example, if M is taken as 100, K as 250 bytes, and C as 1 M bytes/second, and considering F to be 10000, the following relationship should be satisfied:

Q≦1000000/(100×100×250×10000)=1/25000.

In other words, the sufficiently small file list requesting frequency is once in about 7 hours.

<<In the case of Connection Form 2>>

In the following, explained is an example of the method of adjusting the communication traffic in the connection form 2 of nodes in the network. The connection form 2, as already explained regarding FIG. 4 or FIG. 5, is the form of communication in which the communication between a node and another node is done either by a direct connection or by an indirect connection depending on whether the another node is directly connected.

In the case of the communication form 1 in which all communications between nodes are done by direct connections, because the network configuration is flat, a method of adjusting the communication traffic was determined assuming the total of traffic between the nodes as the load on the network.

However, in the case of the connection form 2, the load on the network placed by a communication between a pair of nodes places depends on the number of nodes that relay the communication (called a hop number). In other words, an indirect communication between indirectly connected nodes needs mediation of other nodes (executing a routing function) between them, thus increasing the effect to the network traffic by that amount.

Further, depending on the relationship between the virtual network topology and the physical connection form, the load may be locally placed on the network, or otherwise may be placed on the entire network.

In order to handle these effects in a simple manner, we consider an average hop number H and a number S of network segments.

The segment is a unit physically constituting a network, and the overall network is configured by the mutual connection of a plurality of segments which are sub-networks by themselves. Therefore, communication can be made between the nodes within a particular segment without affecting other segments.

From these considerations, as a hop number HO (the number of intermediate nodes) between a particular pair of nodes becomes larger, the number of communications becomes higher, and the load on the network becomes high (H0/1) compared to the communication using direction connections (the hop number is 1). Further, as the number S of segments becomes larger, the load placed on the entire network by the communications between nodes with direct connections becomes small (1/S) compared to when not segmented (S=1).

Therefore, the load of the communication traffic on the network in the case of the connection form 2 can be estimated to be the product of H/S and the communication traffic in the case of the connection form 1 of only direct connections, where H is the average hop number between nodes, and S is the number of segments in the network.

By multiplying the time average of the prescribed allocated traffic in the case of the connection form 1 described earlier by a coefficient of H/S, an appropriate upper limit value for N/T can be set.

In this manner, according to the method of managing the directory information, the management apparatus and the management system according to the present preferred embodiment, even when making inquires related to the directory information to the other nodes, the communication load on the network can be suppressed not to be excessive. In other words, each node that receives an inquiry carries out data communication by adjusting the time average traffic of each node not to exceed a prescribed value. This can suppress the increase of the load so that other more important processes such as file transfer are not affected or disturbed.

The scope of the present invention is not limited to the abovementionted preferred embodiment. Any modifications of the preferred embodiment are included in the scope of the present invention as long as they do not depart from the spirit and scope of the present invention.

What is claimed is:

1. A method of managing directory information in a network system in which files are distributed and shared between a plurality of nodes, the method comprising the steps of:
issuing a request for a list of files stored in the second node from a first node to a second node, the first node storing directory information indicating which node holds a file;
transmitting the list from the second node, which has received the request, to the first node while adjusting time average traffic not to excess a predetermined value; and
updating the directory information stored in the first node based on the list received from the second node.

2. The method of claim 1, wherein in the step of transmitting the list, the list is transmitted in units of a predetermined amount at predetermined time intervals.

3. The method of claim 1, wherein in the step of transmitting the list, the list is transmitted in a way that a part of the list in which a higher priority file is listed is transmitted more preferentially.

4. The method of claim 3, wherein the priority of the files stored in the second node is determined based on time at which the files were created or updated.

5. The method of claim 3, wherein the priority of the files stored in the second node is determined based on how many times or how frequently the files were referred to.

6. The method of claim 3, wherein in the step of issuing the request, information for determining a priority of files is transmitted from the first node to the second node, and a priority of files is determined by the second node based on the transmitted information.

7. The method of claim 1, wherein in the step of issuing the request, information for selecting a file is transmitted from the first node to the second node, and the second node selects, based on the transmitted information, a file to be listed on the list.

8. The method of claim 1, wherein in the step of transmitting the list, before starting to transmit the list, a reply saying that the request for the list has been accepted is transmitted from the second node to the first node.

9. A network system in which files are distributed and shared between a plurality of nodes, the network system comprising:
a first node which is adapted to store directory information indicating which node stores a shared file;
a second node which is able to communicate with the first node,
wherein the first node includes:
a first storage section for storing the directory information;
a request section which is adapted to request from the second node a list of files stored in the second node; and
an updating section which is adapted to update the directory information based on the list received from the second node,
and, the second node includes:
a second storage section for storing the files;
a list generation section which is adapted to generate the list of the files stored in the second storage section; and
a transmission section which is adapted to transmit, when the list of the files is requested from the second node, the list generated by the list generation section while adjusting time average traffic not to excess a predetermined value.

10. The network system of claim 9, wherein the transmission section transmits the list in units of a predetermined amount at predetermined time intervals.

11. The network system of claim 9, wherein the list generation section generates the list on which the files stored in the second node are listed in a priority order, and the transmission section transmits the list in a way that a portion of the list in which a higher priority file is listed is transmitted more preferentially.

12. The network system of claim 11, wherein the priority of the files stored in the second node is determined based on time at which the files were created or updated.

13. The network system of claim 11, wherein the priority of the files stored in the second node is determined based on how many times or how frequently the files were referred to.

14. The network system of claim 11, wherein the request section transmits information for determining a priority of files to the second node, and the second node determines a priority of files based on the transmitted information.

15. The network system of claim 9, wherein the request section transmits information for selecting a file to the second node, and the list generation section selects, based on the information from the request section, a file to be listed on the list.

16. The network system of claim 9, wherein before starting to transmit the list, the transmission section replies to the first node that the request for the list has been accepted.

17. An information processing apparatus in a network system in which files are distributed and shared between a plurality of information processing apparatuses, the information processing apparatus comprising:
a file storage section for storing files shared with other information processing apparatuses;
a directory storage section which is adapted to store directory information indicating which information processing apparatus stores which of the files shared in the network system;
a request section which is adapted to request from a first another information processing apparatus a list of files stored in the another information processing apparatus;
an updating section which is adapted to update the directory information stored in the directory storage section based on the list received from the first another information processing section;
a list generation section which is adapted to generate a list of the files stored in the file storage section; and
a transmission section which is adapted to transmit, when the list of the files is requested by a second another information processing apparatus, the list generated by the list generation section to the second another information processing apparatus while adjusting time average traffic not to excess a predetermined value.

18. The information processing apparatus of claim 17, wherein the transmission section transmits the list in units of a predetermined amount at predetermined time intervals.

19. The information processing apparatus of claim 17, wherein the list generation section generates the list on which the files stored in the file storage section are listed in a priority order, and the transmission section transmits the list in a way that a portion of the list in which a higher priority file is listed is transmitted more preferentially.

20. The information processing apparatus of claim 19, wherein the priority of the files stored in the file storage section is determined based on time at which the files were created or updated.

21. The information processing apparatus of claim 19, wherein the priority of the files stored in the file storage section is determined based on how many times or how frequently the files were referred to.
